(19) United States
(12) Patent Application Publication
(10) Pub. No.: US 2011/0241248 A1
(43) Pub. Date: Oct. 6, 2011

(54) MULTI-LAYERED FIRE-RESISTANT PLASTIC MATERIAL

(75) Inventors: Michael Merkel, Dusseldorf (DE); Norbert Eisen, Koln (DE); Gunter Gansen, Neuss (DE)

(73) Assignee: Bayer MaterialScience AG, Leverkusen (DE)

(21) Appl. No.: 13/130,354

(22) PCT Filed: Nov. 13, 2009
(86) PCT No.: PCT/EP2009/008079

§ 371 Date: Jun. 14, 2011

(30) Foreign Application Priority Data
Nov. 21, 2008 (DE) 10 2008 058 421.5

(51) Int. Cl. B29C 45/16; B32B 27/40; B32B 3/00

(52) U.S. Cl. 264/255; 428/423.3; 428/332

(57) ABSTRACT

The present invention relates to a multi-layered plastic material, a process for the preparation thereof, and the use thereof. A multi-layered plastic material having a bending modulus of elasticity of >250 N/mm², comprising a polyurethane support layer containing red phosphorus and/or melamine and/or melamine derivatives, and laminated thereon at least one polyurethane cover layer containing expandable graphite.

The present invention relates to a multi-layered plastic material, a process for the preparation thereof, and the use thereof.

For many plastic materials, a sufficient flame retardancy is necessary, as required by various legal provisions and a number of other regulations. The proof that the plastic materials meet the respective requirements of fire protection technology is presented by means of a wide variety of different fire protection tests, which are usually directed to the application of the plastic material. In general, the plastic materials must be equipped with so-called flame retardants to pass these fire protection tests.

In the field of rail vehicle construction, there have been different fire prevention regulations. In the course of its standardization, the European Union put the European Fire Testing Standard EN 45545 in motion, which has in the meantime been published as prCEN/TS 45545, which all plastic materials intended to be used in rail vehicle construction will have to meet in the future. In the material requirements, a distinction is made between so-called hazard levels (HL). Which hazard level the respective plastic material has to meet depends on the exact operation and design category of the vehicle in which the plastic material is supposed to be employed. A hazard level of 3 represents the highest requirements with respect to the demanded fire protection, while a hazard level of 1 represents the lowest.

As indicated above, the plastic materials are mostly equipped with one or more flame retardants in order to provide them with a fire retardancy that is sufficient for the respective application. To date, the flame retardants have mostly been distributed homogeneously in the actual plastic material, which is disadvantageous from an economical point of view, since the flame retardants are mainly needed on the surface facing the source of fire, but not or to a far lesser extent in the interior of the plastic material.

Therefore, there have been efforts for quite some time now to provide multi-layered material in which the flame retardants are enriched in the outermost layer or outer layers.

Thus, EP 1 348 542 A1 describes foam-containing composite systems consisting of polyiso-cyanurate B1, polyisocyanurateimide B1 or polyimide B1 foams provided with intumescent or ablative insulating layer formers as a cover layer and optionally intermediate layers. The cover layer is applied later to the foam, which is at first prepared separately. A drawback of such composite systems is, on the one hand, the use of PIR foams, since these are more difficult to prepare, i.e., at higher temperatures, as compared to, for example, PUR foams, and also have poorer mechanical properties. On the other hand, B1 foams typically have densities in a range of from 30 to 80 kg/m³ and are therefore rather unsuitable for structural components because of their insufficient mechanical properties.

Similarly, DE 196 17 592 A1 discloses plastic laminates in which at least one layer a) contains one or more synthetic resins selected from the group consisting of bitumen, epoxy resins, polyurethanes, polyolefins, silicones, rubber, synthetic thermoplasts, acrylate polymers, vinyl chloride polymers, urea formaldehyde resins and melamine formaldehyde resins, and b) an intumescent mixture. The process described therein is also to be evaluated as rather tedious, since the preparation of the plastic part is first effected, which is subsequently coated by rolling, spraying, dipping etc. Therefore, such composite materials have a rather poor surface quality due to process conditions.

WO 00/35999 A1 describes a process for preparing a rigid polyurethane foam by reacting a polyisocyanate, a polyol, a halogenated reactive compound, a blowing agent, a catalyst, expandable graphite and an additional flame retardant selected from the group of phosphonate esters, phosphate esters, halogenated phosphate esters, or a combination thereof. The plastic materials obtainable according to this specification also have a low density and thus have only limited suitability as a structural component. In addition, halogenated polyols are employed for preparing polyurethane foams, which has an adverse effect on flue gas toxicity.

Thus, it has been the object of the present invention to provide a polyurethane-containing plastic material that reduces or even eliminates the drawbacks of the prior art. In particular, the object is to provide a plastic material exhibiting a sufficient flame retardancy, in particular, that meets the Fire Testing Standard EN 45545 (wherein reaching a hazard level of 1 to 3, especially 2 to 3, is considered sufficient). It is a further object to optimize the plastic material economically in terms of the flame retardant, i.e., with respect to both the amounts employed and the distribution within the plastic material, while the sought fire protection is achieved.

In a first embodiment, the object of the present invention is achieved by a multi-layered plastic material having a bending modulus of elasticity of >250 N/mm², comprising a polyurethane support layer containing red phosphorus and/or melamine and/or melamine derivatives, and laminated thereon at least one polyurethane cover layer containing expandable graphite.

Surprisingly, it has been found that such a plastic material with at least two layers meets at least hazard level 2 of EN 45545 and thus can be employed for the essentially most important fields of application in rail vehicle construction.

A polyurethane support layer containing red phosphorus and melamine and/or melamine derivatives is described in EP 0 941 283 B1, which is herewith included by reference in its entirety. According to the invention, this support layer is particularly preferred. In particular, the polyisocyanates and polyols disclosed in this patent specification are also employed in the present invention, not only for the just mentioned support layer, but also for the polyurethane cover layer containing expandable graphite.

Preferably, the cover layer contains expandable graphite in an amount of from 5 to 50% by weight, especially from 20 to 25% by weight, respectively based on the total weight of the cover layer. Smaller contents of expandable graphite lead to an insufficient flame retardancy. Although larger amounts improve the extent of flame retardancy, they not only have an adverse effect on the processability of the polyol suspension containing expandable graphite, but also lead to a significant increase of costs for the plastic material obtained. Too high a proportion of flame retardants also leads to a deterioration of essential mechanical properties, especially impact strength.

Preferably, the cover layer further contains Al(OH)₃ (such as Martina® ON320), more preferably in an amount of from 5 to 50% by weight, even more preferably in an amount of from 20 to 25% by weight, respectively based on the total weight of the cover layer. The combination of at least one intumescent (expandable graphite) and one ablative (Al(OH)₃) flame retardant, i.e., a water-cleaving (Al(OH)₃) flame retardant, surprisingly has proven particularly advantageous. As to the advantages and disadvantages of the amounts of Al(OH)₃ employed, the same applies as stated above with respect to expandable graphite.

In addition to expandable graphite and optionally Al(OH)₃, the cover layer may also contain other flame retardants. Basically, all flame retardants usually employed in polyurethanes are suitable:
a) phosphorus-containing flame retardants: e.g., phosphate esters, phosphonates, phosphinates, red phosphorus, ammonium polyphosphate;
b) mineral flame retardants: e.g., aluminum hydroxide, magnesium hydroxide, ammonium sulfate;
c) nitrogen-containing flame retardants: melamine, melamine derivatives;
d) halogen-containing (bromine- and/or chlorine-containing) flame retardants: e.g., polybrominated diphenylethers, hexabromocyclododecane, tetrabromobisphenol A, brominated polyols, brominated phenols, tetrabromophthalic acid anhydride, tris(chloropropyl) phosphate, tris(dichloropropyl) phosphate, tris(2-chloroethyl) phosphate;
e) other flame retardants include, for example, borates, antimony compounds and/or zinc compounds.

Preferably, the sums of the amounts of all flame retardants in the cover layer are within a range of from 10 to 70% by weight, based on the total weight of the cover layer. Smaller amounts result in insufficient flame retardancy. For even larger amounts than 70% by weight, the weight proportion of polyurethane in the cover layer is so small that the stability of the cover layer is insufficient. The amount of halogen-containing flame retardants is selected to meet the provisions of EN 45545 relating to flue gas toxicity.

Preferably, the support layer contains red phosphorus and melamine and/or melamine derivatives at a weight ratio of from 1:7.5 to 1:100, respectively based on the red phosphorus. Preferably, the amounts of red phosphorus are from 2 to 30% by weight; the amounts of melamine and/or melamine derivatives are preferably within a range of from 5 to 50% by weight. The data in percent by weight are respectively based on the total weight of the support layer.

In addition to red phosphorus and melamine and/or melamine derivatives, the support layer may also contain other flame retardants as mentioned above. Preferably, the sum of the amounts of all flame retardants in the support layer is within a range of from 7 to 70% by weight, based on the total weight of the support layer.

Generally, a smaller proportion (in % by weight) of flame retardants is employed in the support layer as compared to the cover layer. This results in a saving of flame retardants as compared to those embodiments in which the flame retardant or retardants are homogeneously distributed in the plastic material.

Preferably, the support layer has a layer thickness within a range of from 2.5 mm to 30 mm, especially from 2.5 mm to 15 mm. The cover layer preferably has a layer thickness of from 1 to 3 mm.

In the plastic material according to the invention, the cover layer is of particular importance in terms of fire protection. Above all, the support layer is supposed to ensure a sufficient mechanical strength of the plastic material. A small layer thickness of the cover layer results in insufficient flame retardancy, whereas a greater layer thickness, although increasing the flame retardancy, also results in high material costs. To ensure a sufficient mechanical stability/strength, the support layer must have a certain minimum layer thickness, whereas a large layer thickness is undesirable due to the accompanying increase of weight.

Preferably, the multi-layer plastic material has a density within a range of from >400 kg/m³ to 1600 kg/m³.

Preferably, the cover layer has a density within a range of from >700 kg/m³ to 1600 kg/m³.

Preferably, the support layer has a density within a range of from 200 kg/m³ to 1600 kg/m³.

Preferably, the plastic material has a bending modulus of elasticity within a range of from 800 N/mm² to 4000 kN/mm².

Preferably, the support layer is an integral foam, i.e., a foam whose outer boundaries, although consisting essentially of the same plastic material, are compacted as compared to the interior of the plastic material, i.e., have a higher density.

Preferably, the plastic material comprises a further cover layer and/or decorative layer containing expandable graphite, laminated to the support layer, for example, a paint or a deep-drawn sheet. A typical example in this connection is a sandwich structure of a cover layer, support layer and cover layer, i.e., one in which both main boundary layers are essentially protected from the action of flames.

In a second embodiment, the object of the invention is achieved by a process which is characterized in that a layer of a polyurethane material containing expandable graphite is placed in a mold, and a layer containing red phosphorus and/or melamine and/or melamine derivatives is applied thereto.

Preferably, the layer of a polyurethane material containing the expandable graphite is placed into a mold by spraying, the mold is closed, and the layer containing red phosphorus and/or melamine and/or melamine derivatives is subsequently applied by back-foaming or back-injection.

By such back-foaming or back-injection, the material of the support layer can be compacted at the boundaries of the support layer depending on the process conditions, which thus results in the support layer being formed as an integral foam.

As components for preparing the PUR molded foam of the support layer and of the decorative layer, polyols and isocyanates sufficiently known in the prior art are employed. As to the polyol component, it has proven possible to replace part thereof by renewable raw materials, such as castor oil or other known vegetable oils, chemical reaction products thereof, or derivatives thereof Such a use is not accompanied by any deterioration of the properties of the finished polyurethane foam molded part and in advantageous in that such foam parts substantially contribute to sustainability.

In this process, it is preferred that a jet containing flame retardant is directed into the jet of the foam raw material of the components of the support layer and/or cover layer, or a jet of the foam raw material of the components of the support layer and/or cover layer is directed into the jet containing flame retardant. This mutual incorporation of the two materials achieves an optimum wetting of the flame retardant. In addition, the mixing of the flame retardant into a liquid foam raw material can be dispensed with.

For an even better wetting of the flame retardant with the foam raw material, it is preferred, in particular, that the flame retardant and the foam raw material are sprayed to form a polyurethane foam molded part.

In addition, due to the later metering of the respective flame retardant into the reaction jet, there is no risk of damaging the pumps, mixing heads and nozzles by the abrasive properties of these flame retardants.

A further preferred process variant is characterized in that a foam layer containing flame retardant (expandable graphite) is placed in a mold, especially in a die, and another foam material containing red phosphorus and/or melamine and/or melamine derivatives is applied thereto.

The foam layer containing expandable graphite is preferably placed in the mold by spraying an open mold wholly or in part.

Since inclined or vertical surfaces can also be sprayed in the process according to the invention, an increased thixotropy may be reasonable. Such increased thixotropy can be achieved by using the different reactivities of the starting materials (such as amines, polyethers, amino-modified polyethers, varied catalysis etc.) for selectively adjusting the viscosity of the reaction mixture. Such a modification for selectively adjusting the thixotropy is known from the literature. Thus, Guether, Markusch and Cline described the use of “Non-sagging Polyurethane Compositions” on the Polyurethanes Conference 2000 (Oct.8 to 11, 2000).

In a third embodiment, the object of the invention is achieved by the use of the plastic material according to the invention in rail vehicle construction.

### EXAMPLE

### a) Comparative Example 1

| Polyol component: | |
|---|---|
| 100 parts by weight (pbw) of | Baydur ® VP.PU 601K20, |
| | OH number 515 |

| Flame retardant: | |
|---|---|
| 85 pbw (25% by weight) | Melamine |
| 14 pbw (4% by weight) | Exolite ® RP 6520 [containing about |
| | 45% by weight red phosphorus] |

| Isocyanate component: | |
|---|---|
| 140 parts by weight (pbw) of | Desmodur ® 44P01 |

The plastic material obtained had a density of 600 kg/m³. It meets DIN 5510, but not EN 45545.

### b) Comparative Example 2

| Polyol component: | |
|---|---|
| 100 parts by weight (pbw) of | Baydur ® VP.PU 71BD04, |
| | OH number 480 |

| Flame retardant: | |
|---|---|
| 60 pbw (21%) | Melamine |
| 6 pbw (2%) | Exolite ® RP 6520 |

| Isocyanate component: | |
|---|---|
| 120 parts by weight (pbw) of | Desmodur ® 44V10L |

The plastic material obtained had a density of 1200 kg/m³. It meets DIN 5510, but not EN 45545.

### c) Comparative Example 3

| Polyol component: | |
|---|---|
| 100 parts by weight (pbw) of | Baydur ® 6110B, |
| | OH number 475 |
| 0.8 parts by weight (pbw) of | water |

| Flame retardant: | |
|---|---|
| 225 parts by weight (pbw) (42%) | Martinal ® ON 320 |
| 60 parts by weight (pbw) (11%) | Exolite ® AP 422 |

| Isocyanate component: | |
|---|---|
| 145 parts by weight (pbw) of | Desmodur ® 44V10L |
| 3 parts by weight (pbw) of | Baylith ® L Paste |

The plastic material obtained had a density of 800 kg/m³. It meets NF-F 16-101 (classification M2, F2), but reaches only HL 1 in EN 45545.

### d) Comparative Example 4 essentially corresponds to WO 00/35999 A1 in Example 1, but without a physical blowing agent (R141b).

| Polyol component: | |
|---|---|
| 100 parts by weight (pbw) of | Baydur ® VP.PU 601K20, |
| | OH number 515 |

| Flame retardant: | |
|---|---|
| 33 parts by weight (pbw) (10%) | Ixol ® B251 |
| | (halogenated polyol) |
| 16 parts by weight (pbw) (5%) | DEEP |
| | (diethyl ethylphosphonate) |
| 16 parts by weight (pbw) (5%) | expandable graphite |

| Isocyanate component: | |
|---|---|
| 140 parts by weight (pbw) of | Desmodur ® 44P01 |

The plastic material obtained fails EN 45545.

### e) Example 1 (According to the Invention)

### Cover Layer:

| Polyol component: | |
|---|---|
| 25 parts by weight (pbw) of | Multitec ® VP.PU 20MT01, |
| | OH number 465 |
| 75 parts by weight (pbw) of | Multitec ® VP.PU 20MT02, |
| | OH number 110 |
| Flame retardant: | |
| 20%* | Martinal ® ON 320 |
| 20%* | Expofoil ® PX99 |
| | (expandable graphite) |
| Isocyanate component: | |
| 106 | Multitec ® 10MT03 |
| Support layer: | |
| Polyol component: | |
| 100 parts by weight (pbw) of | Baydur ® VP.PU 60IK20 |
| Flame retardant: | |
| 5%* | Exolite ® RP6520 |
| 10%* | Melamine |
| Isocyanate component: | |
| 125 | Desmodur ® 44P01 |

*percent by weight, based on the respective layer of the molded part

The plastic material obtained had a density of 750 kg/m³ (cover layer: 950 kg/m³; support layer: 7001 kg/m³). It meets HL 2 in EN 45545.

As shown above, Comparative Examples 1, 2 and 4 do not meet the European Fire Testing Standard EN 45545. Even Comparative Example 3 only meets hazard level 1. In contrast, the Example according to the invention meets hazard level 2.

1-19. (canceled)

20. A multi-layered plastic material having a bending modulus of elasticity of greater than 250 N/mm², comprising
a polyurethane support layer containing red phosphorus and/or melamine and/or melamine derivatives, and
a polyurethane cover layer which comprises expandable graphite, wherein the polyurethane cover layer is laminated to the polyurethane support layer.

21. The multi-layered plastic material according to claim 20, wherein said cover layer comprises from 5 to 50% by weight of the expandable graphite, based on the total weight of the cover layer.

22. The multi-layered plastic material according to claim 20, wherein said cover layer comprises from 5 to 50% by weight of Al(OH)₃, based on the total weight of the cover layer.

23. The multi-layered plastic material according to claim 20, wherein said cover layer comprises a total amount of flame retardants of from 10 to 70% by weight, based on the total weight of the cover layer.

24. The multi-layered plastic material according to claim 20, wherein said support layer comprises red phosphorus and melamine and/or melamine derivatives at a weight ratio of from 1:1 to 1:10, respectively based on the red phosphorus.

25. The multi-layered plastic material according to claim 20, wherein said support layer comprises from 2 to 30% by weight of the red phosphorus, based on the total weight of the support layer.

26. The multi-layered plastic material according to claim 20, wherein said support layer comprises from 5 to 50% by weight of the melamine and/or melamine derivatives, based on the total weight of the support layer.

27. The multi-layered plastic material according to claim 20, wherein said support layer comprises a total amount of flame retardants of from 7 to 70% by weight, based on the total weight of the support layer.

28. The multi-layered plastic material according to claim 20, wherein said support layer has a layer thickness of from 2.5 mm to 30 mm.

29. The multi-layered plastic material according to claim 20, wherein said support layer has a layer thickness of from 2.5 mm to 15 mm.

30. The multi-layered plastic material according to claim 20, wherein said cover layer has a layer thickness of from 1 to 3 mm.

31. The multi-layered plastic material according to claim 20, wherein the plastic material has a density of from greater than 400 kg/m³ to 1600 kg/m³.

32. The multi-layered plastic material according to claim 20, wherein said cover layer has a density of from greater than 700 kg/m³ to 1600 kg/m³.

33. The multi-layered plastic material according to claim 20, wherein said support layer has a density of from 200 kg/m³ to 1600 kg/m³.

34. The multi-layered plastic material according to claim 20, wherein the plastic material has a bending modulus of elasticity of from 800 kN/mm² to 4000 kN/mm².

35. The multi-layered plastic material according to claim 20, wherein said support layer is an integral foam.

36. The multi-layered plastic material according to claim 20, wherein the plastic material comprises a further cover layer and/or decorative layer which comprises expandable graphite and wherein the further cover layer and/or decorative layer is laminated to the support layer.

37. A process for preparing the multi-layered plastic material according to claim 20, comprising placing a layer of a polyurethane material comprising expandable graphite in a mold, and applying at least one layer which comprises red phosphorus and/or melamine and/or melamine derivatives to the layer of polyurethane material.

38. The process according to claim 37, wherein the layer of a polyurethane material comprising the expandable graphite is placed into a mold by spraying and then closing the mold, and wherein the layer comprising red phosphorus and/or melamine and/or melamine derivatives is applied by back-foaming or back-injection.

39. A rail vehicle comprising the multi-layered plastic material according to claim 20.
